(19) United States
(12) Patent Application Publication
(10) Pub. No.: US 2017/0285858 A1
(43) Pub. Date: Oct. 5, 2017

(54) INTELLIGENT PRESSURE SENSITIVE DISPLAY

(71) Applicant: Intel Corporation, Santa Clara, CA (US)

(72) Inventors: Mikko Kursula, Lempaaia (FI); Mika Hakkinen, Kammenniemi (FI); Seppo Vesamaki, Tampere (FI); Jukka Leppanen, Pirkkala (FI); Petri T. Mustonen, Tampere (FI)

(73) Assignee: Intel Corporation, Santa Clara, CA (US)

(21) Appl. No.: 15/085,342

(22) Filed: Mar. 30, 2016

(51) Int. Cl. G06F 3/041; G06F 3/044; G06F 3/01; H04B 1/3827

(52) U.S. Cl. CPC G06F 3/0418; H04B 1/3833; G06F 3/0414; G06F 3/044; G06F 3/016; G06F 2203/04105; G06F 2203/04106; G06F 2203/04104

(57) ABSTRACT

In one example a display assembly for an electronic device comprises a first cover member coupled to a second cover member to define a first chamber, a fluid disposed in the chamber, and a pressure sensor coupled to the chamber to detect a change in pressure in the fluid disposed in the first chamber. Other examples may be described.

### BACKGROUND

The subject matter described herein relates generally to the field of electronic devices and more particularly to an intelligent pressure sensitive display for electronic devices.

Existing displays for some electronic devices include touch screen functionality which relies upon a capacitive touch sensing system to sense the touch of a finger or other pointing device. Such capacitive sensing systems have no way to measure a degree of force applied with a touch. This can result in unintended inputs to the device, for example an unintentional click to a website link when scrolling through a phone display. It may be useful to separate lightweight scrolling touches from heavier touches used to click a website link or other object in the user interface.

Accordingly techniques which enable an intelligent pressure sensitive display for electronic devices may find utility.

### BRIEF DESCRIPTION OF THE DRAWINGS

The detailed description is described with reference to the accompanying figures.

FIG. 1 is a schematic illustration of an electronic device which may be adapted to implement an intelligent pressure sensitive display in accordance with some examples.

FIGS. 2A-2B are schematic front view illustrations of an electronic device which may be adapted to implement an intelligent pressure sensitive display in various configurations.

FIGS. 2C-2G are schematic, side-view illustrations of an intelligent pressure sensitive display in accordance with some examples.

FIG. 3 is a high-level schematic illustration of an exemplary architecture to implement an intelligent pressure sensitive display in accordance with some examples.

FIGS. 4-5 are flowcharts illustrating operations in a method to implement an intelligent pressure sensitive display in accordance with some examples.

FIGS. 6-10 are schematic illustrations of electronic devices which may be adapted to implement an intelligent pressure sensitive display accordance with some examples.

### DETAILED DESCRIPTION

Described herein are exemplary systems and methods to implement an intelligent pressure sensitive display in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

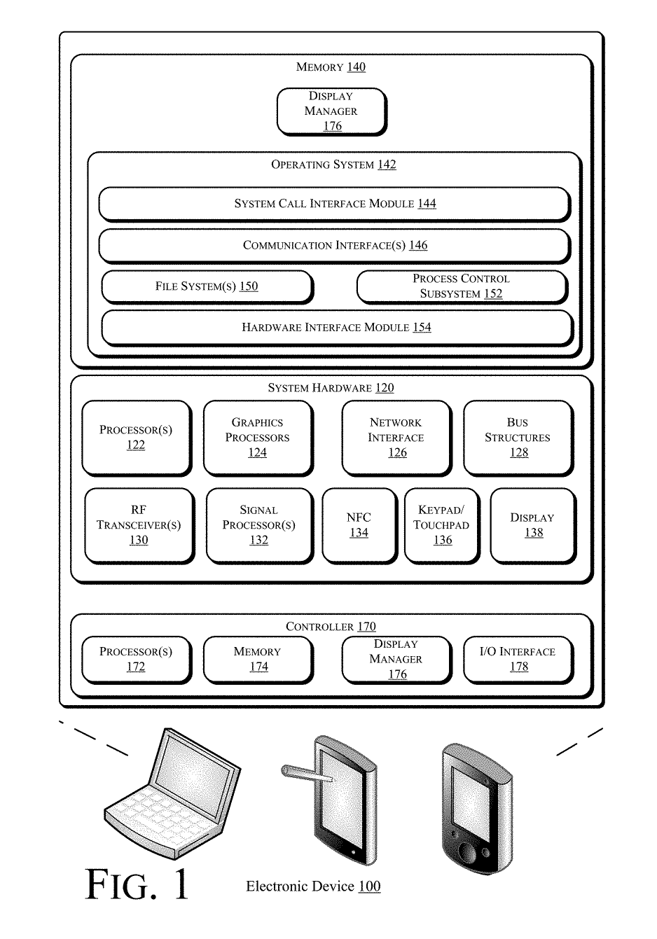

FIG. 1 is a schematic illustration of an electronic device 100 which may be adapted to implement an intelligent pressure sensitive display in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more input/output interfaces such as, e.g., a keypad 136 and a display 138. In some examples electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms

In the embodiment depicted in FIG. 1 the controller 170 comprises a processor 172, a memory module 174, a display manager module 176, and an I/O interface 178. In some examples the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples the display manager module 176 may reside in the memory 140 of electronic device 100 and may be executable on one or more of the processors 122.

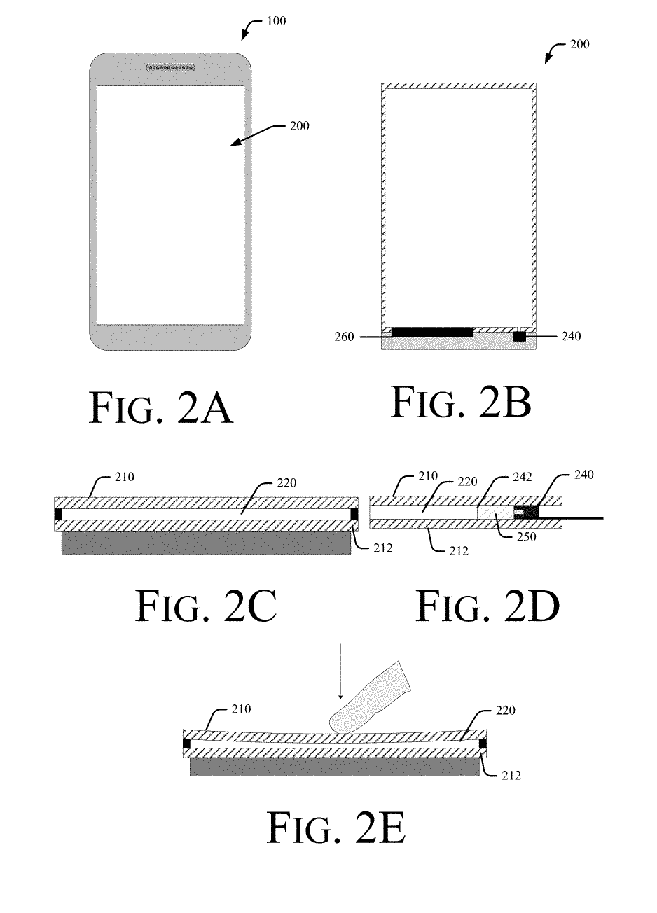

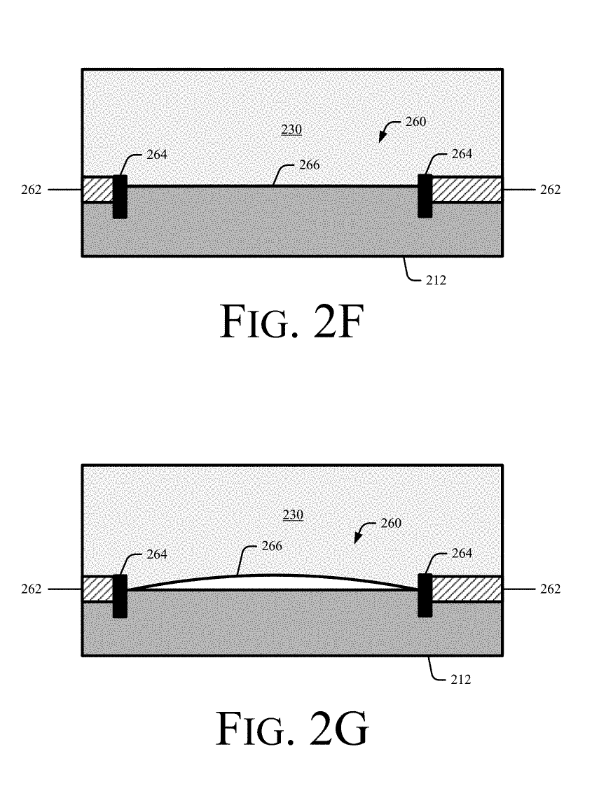

FIG. 2A depicts an electronic device 100 comprising an intelligent pressure sensitive display 200. FIGS. 2B-2G are schematic view illustrations of an electronic device which may be adapted to implement an intelligent pressure sensitive display in various configurations. Referring to FIGS. 2B-2G, in some examples, display assembly 200 for an electronic device 100 comprises a first cover member 210 coupled to a second cover member 212 to define a first chamber 220, a fluid 230 disposed in the first chamber 220, and a pressure sensor 240 coupled to the chamber 220 to detect a change in pressure in the fluid 230 disposed in the first chamber.

In some examples the first cover member 210 comprises at least one of a glass or a translucent polymer. The fluid 230 comprises a chemically inert, translucent fluid such a silicon oil, water, or a glycerol. In some examples the pressure sensor 240 is in direct physical contact with the fluid 230. For example, referring to FIG. 2B, in some examples the pressure sensor 240 may be positioned proximate the first chamber 220 to detect fluid pressure in the first chamber 240. As illustrated in FIG. 2D, in other examples the pressure sensor 240 may be disposed in a second chamber 250 coupled to the first chamber 220 via a flexible membrane 242. In some examples the second chamber 250 may be filled with a chemically inert liquid that has suitable optical and physical properties for this application, e.g., water or a glycerol. In other examples the second chamber 250 may be filled with a compressible gas, e.g., air, argon, or the like.

In some examples pressure sensor 240 may be implemented as a force collector type that use some a structure to collect the force and convert it to electrical signal. Suitable sensors may include, for example, a piezoelectric transducer in which a mechanical force produces electrical voltage output, a strain gauge in which mechanical bending causes electrical resistance change, which is measured, a capacitive sensor in which a diaphragm bending is measured capacitively, an electromagnetic sensor in which bending and/or movement is measured electromagnetically, or an optical sensor in which mechanical deflection is measured optically. Also types of sensors are may be used. For example, sensors which measure variations in liquid or gas physical properties when the pressure changes. Pressure sensor 240 may be communicatively coupled to a printed circuit board 246, which may provide communication connections to controller 170 and/or other electronic components on the electronic device 100.

In some examples the display 200 may comprise a fluid pump 260 capable to pump fluid 230 in the first chamber 220. Referring to FIGS. 2F-2G, in some examples the fluid pump 260 may be implemented as a piezoelectric pump or an electromagnetic actuator disposed between the fluid 230 in chamber 220 and the second cover member 212. In one example a piezoelectric pump 260 comprises a piezoelectric pump element 266 disposed between electrodes 264. Spacers 262 may be used to position piezoelectric pump element 260 in place. Electrodes 264 may be electrically coupled to printed circuit board 246 which may provide an electrical impulse to electrodes 264. The electrical impulse causes the piezoelectric pump element 266 to switch between a first configuration (FIG. 2F) in which the piezoelectric pump element 266 is substantially flat against the second cover member 212 to a second configuration (FIG. 2G) in which the piezoelectric pump element 266 is in a flexed configuration, thereby applying a pressure to the fluid 230 in the chamber 220.

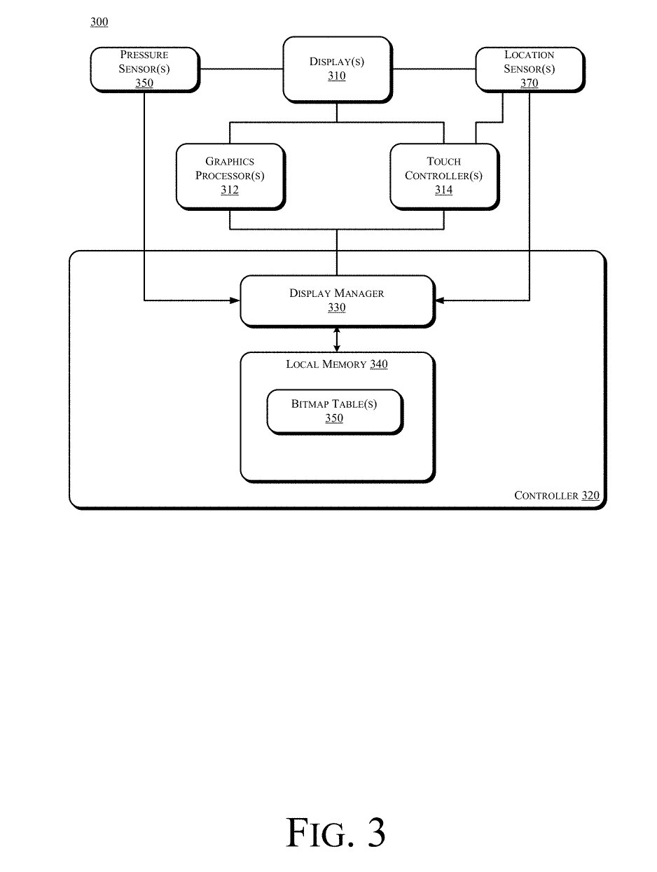

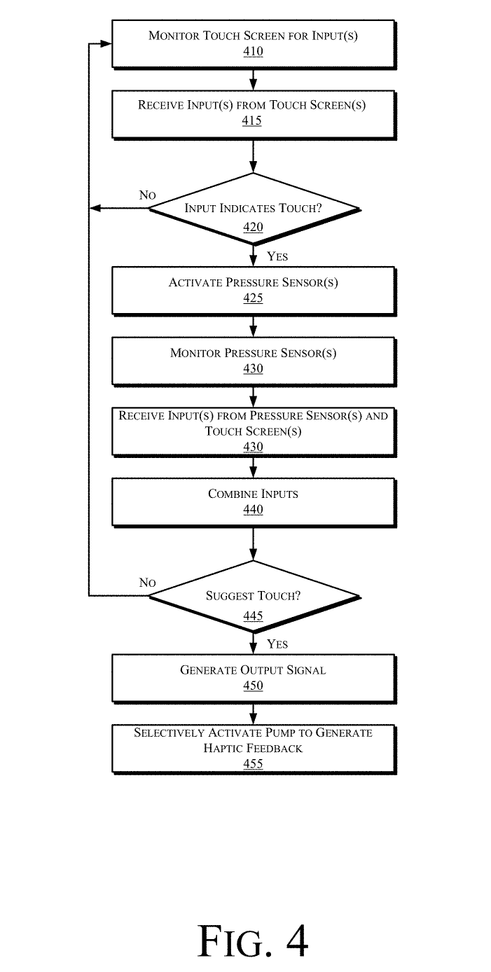

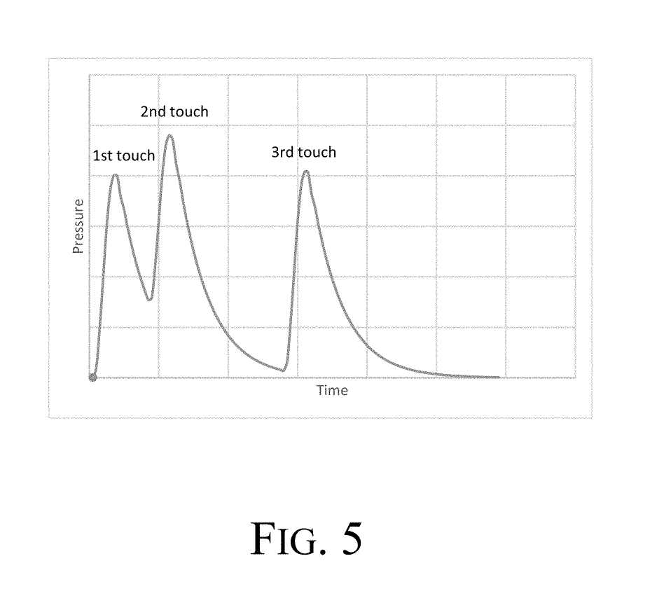

In some examples the display manager module 176 interacts with one or more other components of the electronic device 100 to implement an intelligent pressure sensitive display for an electronic device. FIG. 3 is a high-level schematic illustration of an exemplary architecture 300 to implement an intelligent pressure sensitive display in electronic devices. Referring to FIG. 3, a controller 320 may be embodied as general purpose processor 122 or as a low-power controller such as controllers 170. Controller 320 may comprise a display manager and a local memory 340. As described above, in some examples the display manager 330 may be implemented as logic instructions executable on controller 320, e.g., as software or firmware, or may be reduced to hardwired logic circuits. Local memory 340 may be implemented using volatile and/or non-volatile memory.

Display manager 330 may be communicatively coupled to one or more pressure sensor(s) 350 and fluid pump(s) coupled to display(s) 310, which may be implemented as described above. Further, display manager 330 may be communicatively coupled to one or more graphics processor(s) 312 and touch controller(s) 314 for display 310. Graphics processor 312 manages graphics operations on display(s) 310 and touch controller 314 manages touch-based input/output operations on display(s) 310. One or more location sensor(s) 370, e.g., from a touch screen system, may provide information about the location(s) of touch(es) on the display to the display manager 330 and the touch controller(s) 314. For example, the touch screen system may comprise a capacitive touchscreen and a grid of location sensors to determine the location(s) of the touch(es) on the touchscreen.

In some examples local memory 340 may comprise one or more bitmap tables which comprise bitmaps for images presented on display(s) 310. For example, graphics processor(s) 312 may generate bitmaps corresponding to images presented on display(s) 310. The bitmaps may include coordinates of input/output devices (e.g., buttons, text boxes, or the like) on display 310.

Having described various structures of an intelligent pressure sensitive display in electronic devices, operating aspects of a system will be explained with reference to FIG. 4, which is a flow chart illustrating operations in a method to implement an intelligent pressure sensitive display in electronic devices. The operations depicted in the flowchart of FIG. 4 may be implemented by the display manager 330, alone or in combination with other component of electronic device 100.

Referring to FIG. 4, at operation 410 the display manager 330 receives one or more notification configuration conditions. FIG. 4 is a flowchart illustrating operations implemented by display manager 330 in an electronic device 300. Referring to FIG. 4, at operation 410 the display manager 330 monitors for inputs from other components depicted in FIG. 3. In some examples the display manager 330 may include an input/output (I/O) interface, through which signals may be received from other components.

At operation 415 the display manager 330 receives a touch signal from touch controller 314, and at operation 420 the display manager 330 determines whether the touch signal received in operation 415 indicates a touch from a user. If, at operation 420, the touch signal did not indicate a touch from a user on the display 310 then the display manager 330 continues to monitor for touch signals. By contrast, if at operation 420 a touch signal indicates that the input on the touch screen of the display 310 indicates a touch then control passes to operation 425 and the display manager 330 activates the pressure sensor(s) 350 coupled to the display(s) 310. Thus, in the example operations depicted in FIG. 4 the pressure sensor is activated only when a touch screen input indicates that the touch comes from a user, which reduces power consumption

The display manager 330, at operation 430, monitors the pressure sensor(s) 350 for changes in the pressure of the fluid 230 in the chamber 220. By way of example, when a user depresses a portion of the display 200 as illustrated in FIG. 2E the pressure causes the first cover member 210 to deflect, which applies pressure to the fluid 230 in chamber 220.

In some examples the display manager 330 uses the outputs from the pressure sensor(s) 350 and the touch controller(s) 314 to determine whether a user is attempting to generate an input on the display 310. Thus, at operation 430 the display manager receives inputs from the pressure sensor(s) 350 and the touch controller(s) 314, and at operation 440 the display manager 330 combines the inputs to facilitate distinguishing a deliberate input touch from a user from an accidental touch by a user or by an object. For example, referring to FIG. 5, the display manager 330 may track the pressure of the fluid 230 in the chamber 220 over time. If multiple fingers press the display at exactly the same time, they may cause a single pressure increase peak in the fluid in the chamber and the pressure peak may be greater than a press from a single finger. If multiple fingers touch the display at slightly different time, they will generate multiple pressure changes. Timing of those pressure changes may be combined with touch location sensor information to define the location and force of finger touches.

FIG. 5 illustrates a sequence of three finger presses may look like in the pressure sensor output. For example, referring to FIG. 5, a pressure spike which remains above a threshold value for a predetermined period of time (e.g., 0.1 seconds) may indicate that a deliberate touch was applied to the display assembly 200 and should be processed as an input to the display 200. By contrast, a pressure spike that remains above the threshold for less than the predetermined time period may indicated an accidental touch on the touch screen (i.e., a false positive).

Information from the pressure sensor may be combined with information from the touch controller 314 and/or the location sensor(s) 370 to distinguish between deliberate touches and accidental touches. For example, a palm or other object resting on the display 200 will generate a pressure increase that is static over time or which varies slowly over time. By contrast, deliberate touch input events cause pressure changes which vary with a higher frequency. The display manager can employ high-pass filtering techniques to remove any static or slowly varying events from the results and focus the monitoring on input frequency ranges that typically occurs in touch events.

If, at operation 445 the input(s) to the display do not suggest an input touch then control passes back to operation 410 and the display manager 330 continues to monitor the touch screen for inputs. By contrast, if at operation 445 the input(s) to the display suggest an input touch then control passes to operation 450 and the display manager 330 generates an output signal. In some examples the output signal may be dependent upon the location on the screen on which the touch input was received. By way of example, the display manager may receive touch input coordinates from the touch controller(s) and may correlate the input coordinates with a bitmap of the image on the screen stored in the bitmap table(s) 350 and generate a signal that corresponds to a function presented at the coordinates on the bitmap.

Optionally, at operation 455 the display manager 330 may selectively activate the piezoelectric pump 260 to provide a haptic feedback to the user. By way of example, display manager 330 may apply a sequence of electrical current pulses to the electrodes 264 of the piezoelectric pump 260 to cause the pump element 266 to switch between the configuration depicted in FIG. 2F and the configuration depicted in FIG. 2G.

Thus, the operations depicted in FIG. 4 enable a display for an electronic device to incorporate pressure information from touches applied to facilitate distinguishing between different types of touches on the display and to provide feedback in response to the touches.

In an alternate example the order of inputs from the touch screen and the pressure sensor may be reversed such that inputs from the pressure sensor are monitored to determine whether an input indicates a touch and, in response thereto, the touch screen is activated.

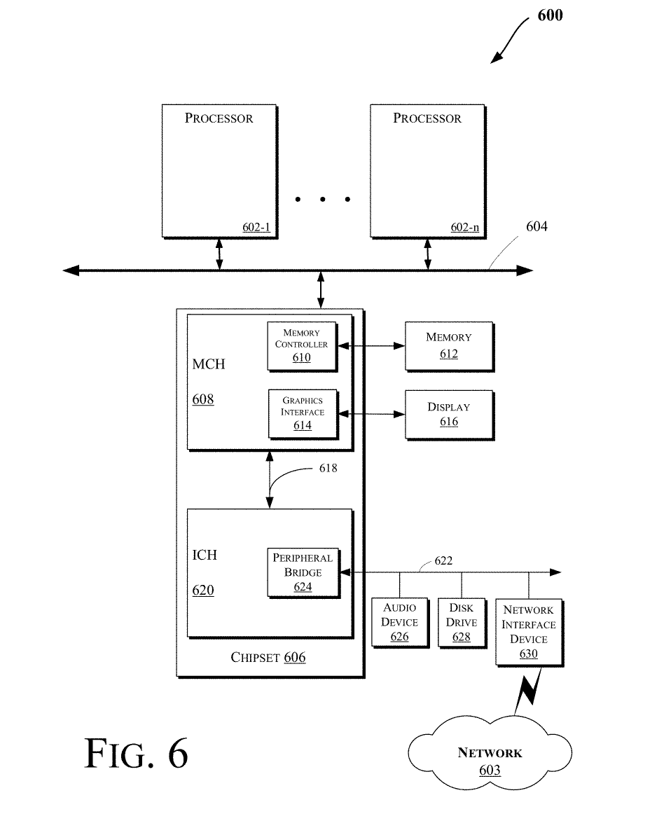

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors depicted of FIG. 1. Also, the operations discussed with reference to FIG. 4 may be performed by one or more components of the system 600.

A chipset 606 may also communicate with the interconnection network 604. The chipset 606 may include a memory control hub (MCH) 608. The MCH 608 may include a memory controller 610 that communicates with a memory 612. The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

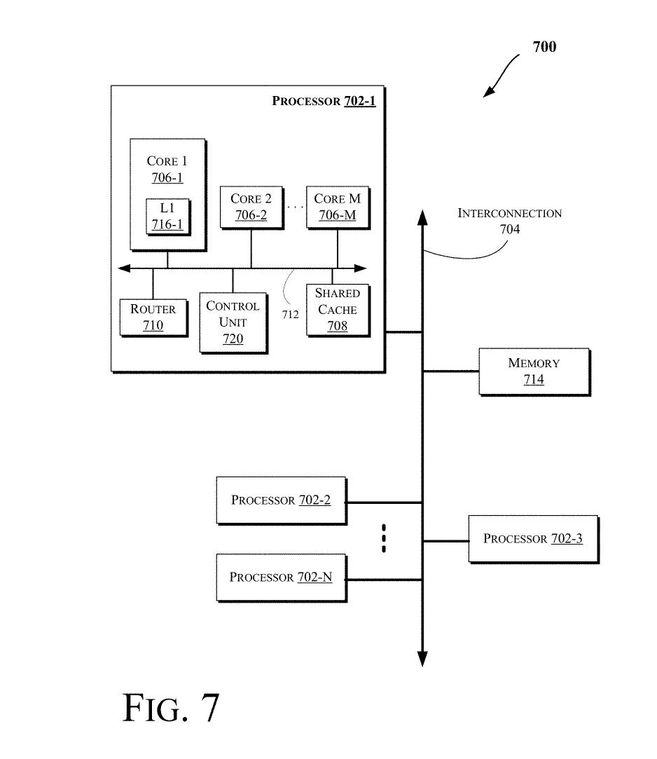

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

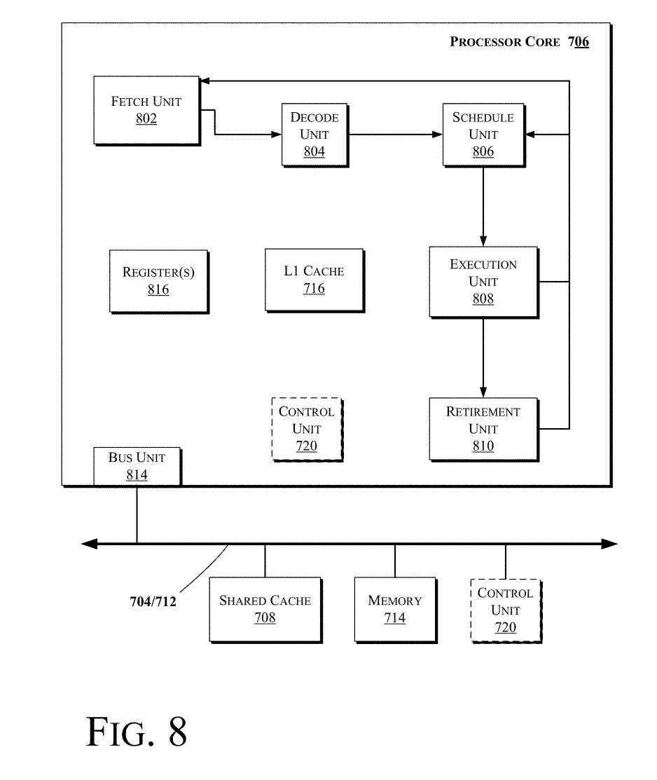

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of micro-operations.

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 4) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

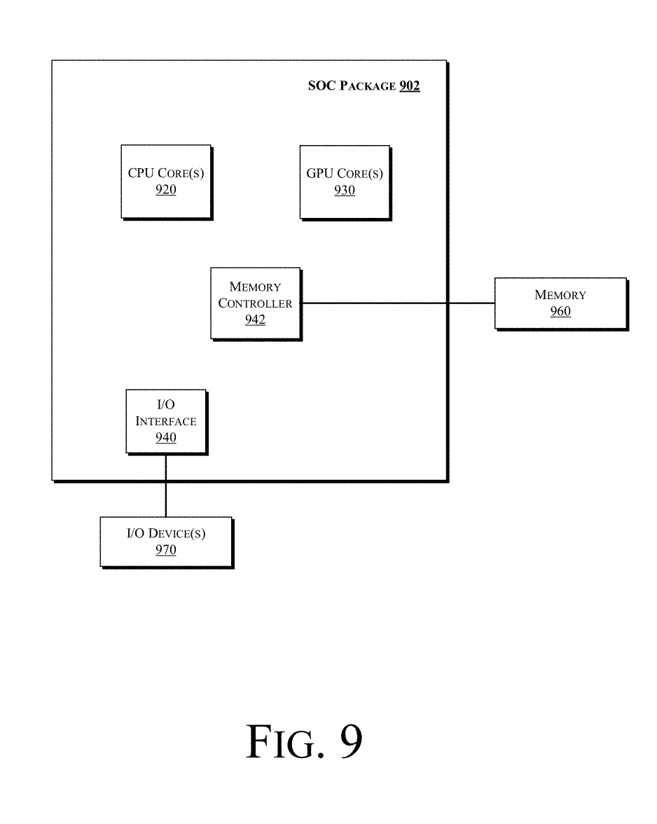

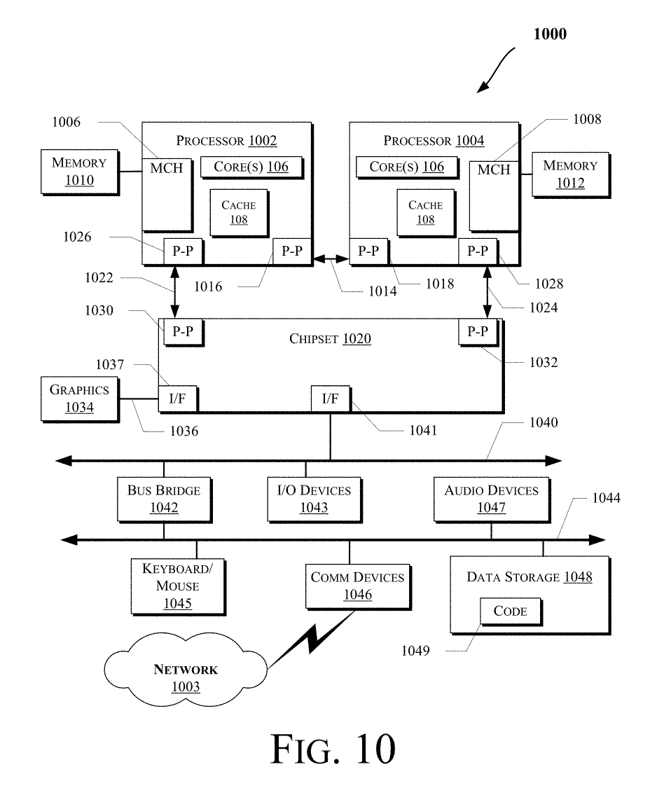

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertains to further examples.

Example 1 is a display assembly for an electronic device, comprising a first cover member coupled to a second cover member to define a first chamber, a fluid disposed in the first chamber, and a pressure sensor coupled to the chamber to detect a change in pressure in the fluid disposed in the first chamber.

In Example 2, the subject matter of Example 1 can optionally include an arrangement in which the display assembly comprises a location sensor to sense a location of a touch on the display.

In Example 3, the subject matter of any one of Examples 1-2 can optionally include a controller communicatively coupled to the pressure sensor and the location sensor and comprising logic, at least partially including hardware logic, to distinguish between a deliberate touch and an accidental touch.

In Example 4, the subject matter of any one of Examples 1-3 can optionally include an arrangement in which the pressure sensor is in direct physical contact with the fluid.

In Example 5, the subject matter of any one of Examples 1-4 can optionally include an arrangement in which the pressure sensor is disposed in a second chamber coupled to the first chamber via a flexible membrane.

In Example 6, the subject matter of any one of Examples 1-5 can optionally include a fluid pump capable to pump fluid in the first chamber.

Example 7 is an electronic device comprising at least one electronic component and a display, comprising a first cover member coupled to a second cover member to define a first chamber, a fluid disposed in the first chamber, and a pressure sensor coupled to the chamber to detect a change in pressure in the fluid disposed in the first chamber.

In Example 8, the subject matter of Example 7 can optionally include an arrangement in which the first cover member comprises at least one of a glass or a translucent polymer.

In Example 9, the subject matter of any one of Examples 7-8 can optionally include an arrangement in which the fluid comprises at least one of a silicon-based oil, a water or a glycerol.

In Example 10, the subject matter of any one of Examples 7-9 can optionally include an arrangement in which the pressure sensor is in direct physical contact with the fluid.

In Example 11, the subject matter of any one of Examples 7-10 can optionally include an arrangement in which the pressure sensor is disposed in a second chamber coupled to the first chamber via a flexible membrane.

In Example 12, the subject matter of any one of Examples 7-11 can optionally include a fluid pump capable to pump fluid in the first chamber.

In Example 13, the subject matter of any one of Examples 7-12 can optionally include a controller communicatively coupled to the pressure sensor and comprising logic, at least partially including hardware logic, to detect a change in an output of the pressure sensor.

In Example 14, the subject matter of any one of Examples 7-13 can optionally include an arrangement in which the logic is further configured to activate the fluid pump in response to a change in the output of the pressure sensor.

In Example 15, the subject matter of any one of Examples 7-14 can optionally include at least one touch location sensor to generate an output corresponding to a location of a touch on the display.

In Example 16, the subject matter of any one of Examples 7-15 can optionally include logic, at least partially including hardware logic, to activate the pressure sensor in response to an output from the at least one touch location sensor.

In Example 17, the subject matter of any one of Examples 7-16 can optionally include logic, at least partially including hardware logic, to combine an output from the pressure sensor with an output from the at least one touch location sensor to distinguish between different types of touches applied to the display.

In Example 18, the subject matter of Example 7-17 can optionally include logic, at least partially including hardware logic, to selectively activate the fluid pump to produce a predetermined haptic feedback in response to a touch input at one or more predetermined locations on the display.

Example 19 is a controller comprising logic, at least partially including hardware logic, to detect a change in an output of a pressure sensor coupled to a chamber in a display defined by a first cover member coupled to a second cover member, wherein a fluid is disposed in the chamber and activate a fluid pump in the chamber in response to a change in the output of the pressure sensor.

In Example 20 the subject matter of Example 19 can optionally include at least one location sensor to generate an output corresponding to a location of a touch on the display.

In Example 21, the subject matter of Example 19-20 can optionally include logic, at least partially including hardware logic, to activate the pressure sensor in response to an output from the at least one location sensor.

In Example 22, the subject matter of Example 19-21 can optionally include logic, at least partially including hardware logic, to combine an output from the pressure sensor with an output from the at least one location sensor to distinguish between different types of touches applied to the display.

In Example 23, the subject matter of Example 19-22 can optionally include logic, at least partially including hardware logic, to selectively activate the fluid pump to produce a predetermined haptic feedback in response to a touch input at one or more predetermined locations on the display.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A display assembly for an electronic device, comprising:
a first cover member coupled to a second cover member to define a first chamber;
a fluid disposed in the first chamber; and
a pressure sensor coupled to the chamber to detect a change in pressure in the fluid disposed in the first chamber.

2. The display assembly of claim 1, wherein the display assembly comprises a location sensor to sense a location of a touch on the display.

3. The display assembly of claim 2, wherein the display assembly further comprises a controller communicatively coupled to the pressure sensor and the location sensor and comprising logic, at least partially including hardware logic, to distinguish between a deliberate touch and an accidental touch.

4. The display assembly of claim 1, wherein the pressure sensor is in direct physical contact with the fluid.

5. The display assembly of claim 1, wherein the pressure sensor is disposed in a second chamber coupled to the first chamber via a flexible membrane.

6. The display assembly of claim 1, further comprising:
a fluid pump capable to pump fluid in the first chamber.

7. An electronic device, comprising:
at least one electronic component; and
a display, comprising:
a first cover member coupled to a second cover member to define a first chamber;
a fluid disposed in the first chamber; and
a pressure sensor coupled to the chamber to detect a change in pressure in the fluid disposed in the first chamber.

8. The electronic device of claim 7, wherein the first cover member comprises at least one of a glass or a translucent polymer.

9. The electronic device of claim 7, wherein the fluid comprises at least one of a silicon-based oil, a water or a glycerol.

10. The electronic device of claim 7, wherein the pressure sensor is in direct physical contact with the fluid.

11. The electronic device of claim 7, wherein the pressure sensor is disposed in a second chamber coupled to the first chamber via a flexible membrane.

12. The electronic device of claim 7, further comprising:
a fluid pump capable to pump fluid in the first chamber.

13. The electronic device of claim 7, further comprising:
a controller communicatively coupled to the pressure sensor and comprising logic, at least partially including hardware logic, to detect a change in an output of the pressure sensor.

14. The electronic device of claim 13, wherein the logic is further configured to:
activate the fluid pump in response to a change in the output of the pressure sensor.

15. The electronic device of claim 13, further comprising at least one touch location sensor to generate an output corresponding to a location of a touch on the display.

16. The electronic device of claim 15, wherein the controller comprises logic, at least partially including hardware logic, to:
activate the pressure sensor in response to an output from the at least one touch location sensor.

17. The electronic device of claim 15, wherein the controller comprises logic, at least partially including hardware logic, to:
combine an output from the pressure sensor with an output from the at least one touch location sensor to distinguish between different types of touches applied to the display.

18. The electronic device of claim 17, wherein the controller comprises logic, at least partially including hardware logic, to:
selectively activate the fluid pump to produce a predetermined haptic feedback in response to a touch input at one or more predetermined locations on the display.

19. A controller comprising logic, at least partially including hardware logic, to:
detect a change in an output of a pressure sensor coupled to a chamber in a display defined by a first cover member coupled to a second cover member, wherein a fluid is disposed in the chamber; and
activate a fluid pump in the chamber in response to a change in the output of the pressure sensor.

20. The controller of claim 19, further comprising at least one location sensor to generate an output corresponding to a location of a touch on the display.

21. The controller of claim 20, wherein the controller comprises logic, at least partially including hardware logic, to:
activate the pressure sensor in response to an output from the at least one location sensor.

22. The controller of claim 21, wherein the controller comprises logic, at least partially including hardware logic, to:
combine an output from the pressure sensor with an output from the at least one location sensor to distinguish between different types of touches applied to the display.

23. The controller of claim 22, wherein the controller comprises logic, at least partially including hardware logic, to:
selectively activate the fluid pump to produce a predetermined haptic feedback in response to a touch input at one or more predetermined locations on the display.
